(19) United States
(12) Patent Application Publication
(10) Pub. No.: US 2014/0097179 A1
(43) Pub. Date: Apr. 10, 2014

(54) ELECTRICAL HEATING DEVICE

(71) Applicant: BorgWarner BERU Systems GmbH, Ludwigsburg (DE)

(72) Inventors: Andrew Conway, Trallee (IE); Peter Mitchell, Trallee (IE); George McCarthy, Castlemaine (IE); Kevin Dukes, Trallee (IE); Bernd Halbrock, Koenigsbach-Stein (DE)

(21) Appl. No.: 14/049,838

(22) Filed: Oct. 9, 2013

(30) Foreign Application Priority Data
Oct. 5, 2012 (DE) 10 2012 109 801.8

(51) Int. Cl. H05B 3/02

(52) U.S. Cl. CPC H05B 3/02
USPC 219/540; 29/611

(57) ABSTRACT

The invention relates to an electrical heating device comprising a heating rod, and heat sinks which are held between flanges of the heating rod, wherein flange sections, defined by cuts in the flanges, are bent to grip and hold the heat sinks. The invention also refers to a method for manufacturing such a heating device.

### RELATED APPLICATIONS

This application claims priority to DE 10 2012 109 801.8, filed Oct. 15, 2012 which is hereby incorporated by reference in its entirety.

### BACKGROUND

The present invention relates to an electrical heating device comprising at least one heating rod and heat sinks attached to the heating rods. An electrical heating device generally of this kind is known from DE 198 48 169 A1.

Such heating devices are used for heating the interior of cars. The heating devices heat a stream of air that passes their heat sinks and is blown into the interior of a car.

The heating device known from DE 198 48 169 A1 uses metal sheets that are slipped onto the heating rods. This involves significant expenditure in manufacturing because a large number of parts have to be handled.

In order to simplify the manufacturing process, DE 10 2006 018 784 A1 teaches integrating the heat sinks into the heating rods. This is done by producing a housing of the heating rods including attached fins by bar extrusion. Holes are then punched into the fins so that air to be heated can flow through the fins. A disadvantage of this method is that bar extrusion of heating rods and fins requires expensive tools. Moreover, the heat transfer from the fins to air flowing through holes in them is not ideal.

### SUMMARY

The present invention shows how an electrical heating device allowing efficient heating of the interior of a car can be produced at lower cost.

According to this disclosure the heating rods have flanges that are used for fastening the heat sinks to the heating rods. The flanges run in the longitudinal direction of the heating rods. Each heat sink is placed between two such flanges. In order to hold the heat sinks in place, the flanges are cut. Flange sections between two such cuts are then bent towards the opposite flange. The bent flange sections thereby grip and hold heat sinks between opposite flanges. Cutting and bending may economically be done with a stamping tool in a single process. It is also possible to cut the flange first and bend sections between cuts later.

The heat sinks may be corrugated sheet metal. Corrugated sheet metal can provide a meandering heat sink with a series of valleys and ridges at low cost. This allows for a large contact area with air flowing through the valley. Heat sinks of corrugated sheet metal are preferably placed between flanges of a heating rod such that the flanges are adjacent to the edges or narrow sides of the metal sheet. Instead of corrugated sheet metal it is also possible to use extruded or cast heat sinks, for example.

Flange sections defined by cuts can advantageously be crimped for holding the heat sinks in place. For example, bent sections can engage meander turning points of a heat sink made of corrugated metal.

The cuts run traverse to the longitudinal direction of the heating rod. Preferably, the cuts run perpendicular to the longitudinal direction of the heating rod. However, the direction of the cuts may be slanted. Then the bent sections are not rectangular, but rather trapezoidal.

Preferably each flange has a series of cuts. Then sections between such cuts can be bent in alternating fashion for holding a heat sink, e.g. every second section is bent. A large number of bent sections improve the connection of the heat sink with the heating rod. For example, there can be a bent section in every valley of a heat sink made of corrugated sheet metal.

From the above explanations it can be understood that the present disclosure refers to the fixing of heat sinks onto heating rods and thus to a method of manufacturing electrical heating devices.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an electrical heating device;

FIG. 2 shows an exploded view of the heating device of FIG. 1; and

FIG. 3 shows a detail of FIG. 1.

### DETAILED DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of the present invention.

The heating device comprises a plurality of heating rods 3 and heat sinks 4. The heating rods may be tubes which contain at least one heating resistor, for example a PTC element. A front end of the heating rods 3 is stuck in a holder 1, a rear end in a holder 2.

The front end of the heating rods 3 is used for electrical connection. A contact sheet 6 protrudes form the front end of the heating rods 3. This contact sheet 6 contacts the heating resistor or resistors of the heating rod 3 and is insulated from a surrounding housing. In the embodiment shown, the tube housing of the heating rods 3 is used for ground connection. The heating rods 3 are therefore stuck through a metal contact sheet 5 that may be arranged at an underside of the holder 1. It is also possible to provide a second contact sheet for each heating rod 1 that protrudes from the front end of the housing like contact sheet 6

As FIG. 3 shows, the heat sinks 4 are held between flanges 10 of the heating rods 3. The flanges 10 run in the longitudinal direction of the heating rod 3. Each flange 10 has a series of cuts that run transverse to the longitudinal direction of the heating rod 3. Flange sections 10a defined by these cuts are bent towards heat sink 4. In this way the bent flange sections 10a grip and hold heat sink 4. Thus the heat sinks 4 can be connected to the heating rod 3 by crimping of flange sections 10a. Unbent flange sections 10b between the bent flange sections 10a may have a greater width that the bent flange sections 10a.

The heat sinks 4 may be corrugated sheet metal, for example of aluminium. Heat sinks 4 made of corrugated sheet metal have a meandering form. Bent flange sections 10a can engage the heat sinks 4 in meander turning points and press the heat sinks 4 against the heating rod 4. Thereby good thermal contact can be achieved.

In the embodiment shown, every second section defined by cuts is bent to grip heat sink 4. Thus flange sections 10a delimited by cuts are bent in alternating fashion.

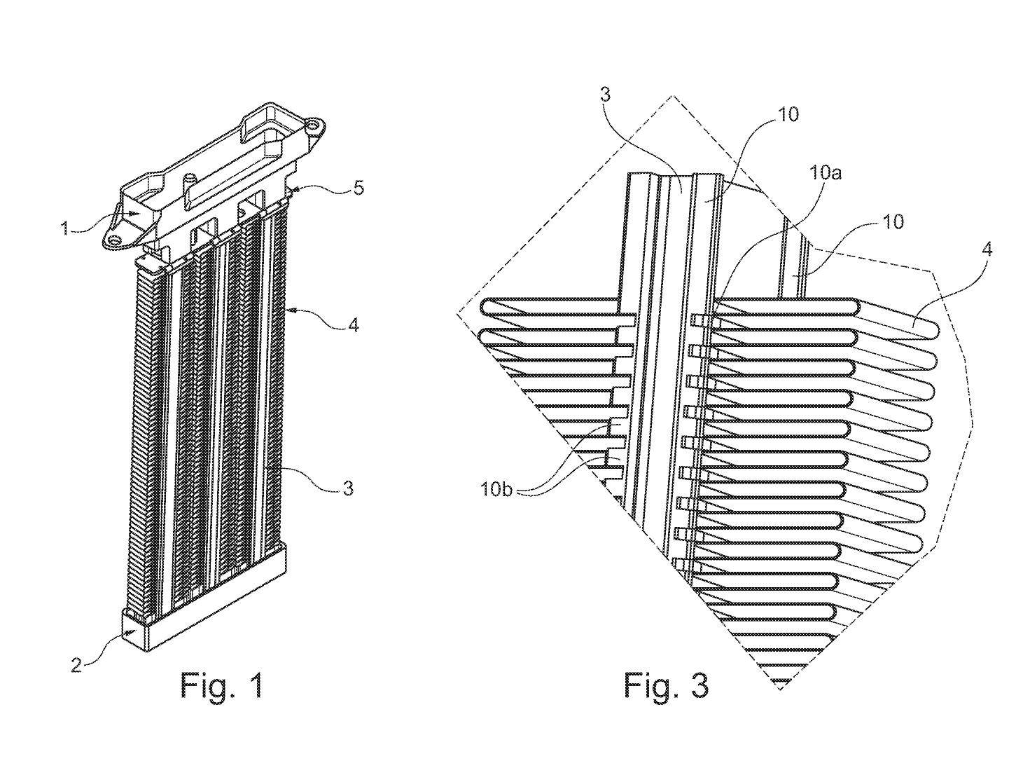

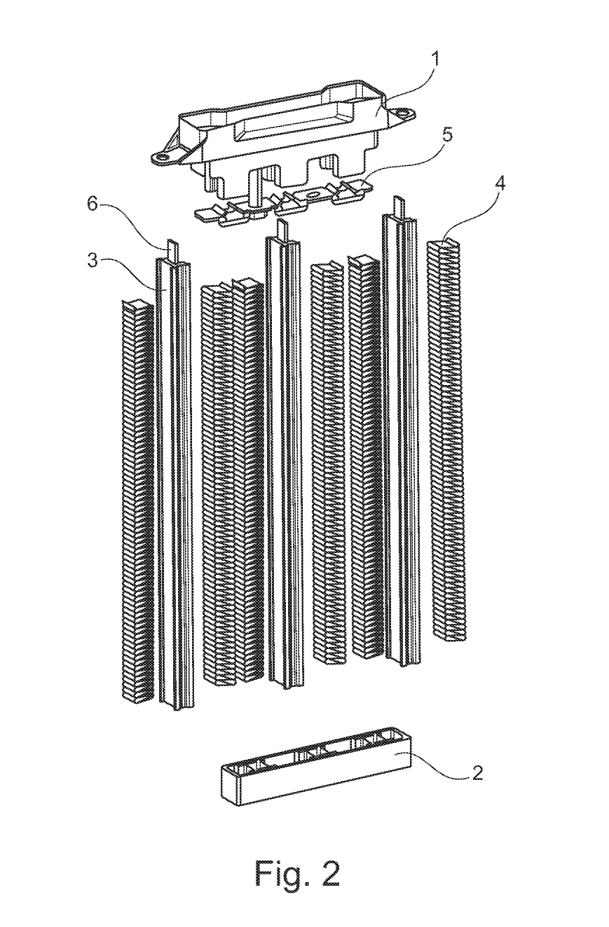

A heating device like the embodiment shown in FIG. 1 can be manufactured by providing a heating rod 3 comprising flanges 10 that run in the longitudinal direction of the heating rod 3. A heat sink 4 is then placed between two such flanges 10 and fixed to the heating rod 3 by crimping, that is by bending flange sections 10a to grip and hold the heat sinks 4. The flanges 10 can be provided with cuts that define the flange sections that are later bent. It is also possible to cut the flanges 10 and bend flange sections 10a between these cuts in one step, for example by a stamping and bending or a shearing and bending process.

The heating rod 3 can be provided by producing a tube housing that has flanges 10 and then placing one or several heating resistors in the tube housing. The tube housing can be made by bar extrusion as described in DE 10 2006 018 784 A1. The resistor or resistors can be placed in the tube housing together with a contact sheet 5 and an insulation layer for insulating the contact sheet from the housing. The tube housing can be compressed for improving thermal contact between the housing and the resistor or resistors. Preferably any compression step is done before the heat sinks 4 are attached to the heating rod 3.

The contact sheet 5 has a contact side contacting the heating resistor or resistors. Preferably this contact side faces a heating rod side on which a heat sink 4 is placed. For compressing, force can be applied between the flanges. The heating resistors may be ceramic PTC heating elements, for example made of barium titantate.

While exemplary embodiments have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electrical heating device, comprising:
a heating rod; and
heat sinks which are held between flanges of the heating rod;
wherein flange sections, defined by cuts in the flanges, are bent to grip and hold the heat sinks.

2. An electrical heating device according to claim 1, wherein the heat sinks comprise corrugated sheet metal.

3. An electrical heating device according to claim 2, wherein the bent sections engage the heat sinks in meander turning points of the corrugated sheet metal.

4. An electrical heating device according to claim 1, wherein the cuts run in a direction that is perpendicular to the longitudinal direction of the heating rod.

5. An electrical heating device according to claim 1, wherein the width of the bent sections is larger than the width of unbent sections between them.

6. An electrical heating device according to claim 1, wherein several heating rods are arranged side by side with heat sinks between them.

7. An electrical heating device according to claim 1, wherein at least one end of the heating rod or heating rods is stuck in a holder.

8. An electrical heating device according to claim 7, wherein the heating rods extend through a contact sheet that is arranged at an underside of the holder.

9. An electrical heating device according to claim 1, wherein the flanges each have a series of cuts and alternating sections between the cuts are bent to hold the heat sinks.

10. A method for manufacturing an electrical heating device comprising the following steps:
providing a heating rod comprising flanges that run in the longitudinal direction of the heating rod;
placing heat sinks between opposing flanges; and
crimping the heat sinks by bending flange sections to grip the heat sinks.
